(19) United States
(12) Patent Application Publication
(10) Pub. No.: US 2025/0112693 A1
(43) Pub. Date: Apr. 3, 2025

(54) COMMUNICATION SYSTEM AND COMMUNICATION METHOD

(71) Applicant: NIPPON TELEGRAPH AND TELEPHONE CORPORATION, Tokyo (JP)

(72) Inventors: Yasuyoshi KOJIMA, Musashino-shi (JP); Daisuke GOTO, Musashino-shi (JP); Kiyohiko ITOKAWA, Musashino-shi (JP); Kazumitsu SAKAMOTO, Musashino-shi (JP); Tomoya KAGEYAMA, Musashino-shi (JP)

(73) Assignee: NIPPON TELEGRAPH AND TELEPHONE CORPORATION, Tokyo (JP)

(21) Appl. No.: 18/727,985

(22) PCT Filed: Jan. 18, 2022
(86) PCT No.: PCT/JP2022/001575

§ 371 Date: Jul. 10, 2024

(51) Int. Cl. H04B 7/195

(52) U.S. Cl. CPC H04B 7/195

(57) ABSTRACT

A capacity estimation unit estimates a channel capacity related to wireless communication between a communication device and a relay device. A scheme determination unit determines a transmission scheme of the data from the communication device to the relay device to be a scheme in which transmission efficiency is lower and transmission quality is higher as the channel capacity is larger, or to be a scheme in which the transmission quality is lower and the transmission efficiency is higher as the channel capacity is smaller.

### TECHNICAL FIELD

The present invention relates to a communication system and a communication method.

### BACKGROUND ART

With the development of Internet of Things (IoT) technology, it has been studied to install IoT terminals including various sensors in various places. For example, it is also assumed that the IoT is used to collect data of a place where it is difficult to install a base station, such as a buoy or a ship on the sea or a mountainous area. Meanwhile, there is a technology of wirelessly communicating with a communication device on the ground by using an unmanned aerial vehicle (UAV) or a geosynchronous satellite (see, for example, Non Patent Literature 1).

### CITATION LIST

### Non Patent Literature

Non Patent Literature 1: Wei Feng, et al. “UAV-aided MIMO communications for 5G Internet of Things”, IEEE Internet of Things Journal, Volume6, Issue2, 2019, p. 1731-1740

### SUMMARY OF INVENTION

### Technical Problem

In a case where a relay device is mounted on a UAV, a geosynchronous satellite, or the like, a channel capacity related to wireless communication between the communication device on the ground and a relay device changes as the relay device moves. Therefore, depending on data transmission timing, an amount of information may be small with respect to the channel capacity, and thus communication resources may not be effectively used. Meanwhile, depending on the transmission timing, the amount of information may be large with respect to the channel capacity, and thus data received by the relay device may be missing.

In view of the above circumstances, an object of the present invention is to provide a communication system and a communication method capable of effectively utilizing communication resources in communication between a relay device that performs communication while moving and a transmission device on the ground.

### Solution to Problem

The first aspect of the present invention is a communication system including a relay device that performs communication while moving and a communication device that transmits data to the relay device, the communication system including: a capacity estimation unit that estimates a channel capacity related to wireless communication between the communication device and the relay device; and a scheme determination unit that determines a transmission scheme of the data from the communication device to the relay device to be a scheme in which transmission efficiency is lower and transmission quality is higher as the channel capacity is larger, or to be a scheme in which the transmission quality is lower and the transmission efficiency is higher as the channel capacity is smaller.

The second aspect of the present invention is a communication method between a relay device that performs communication while moving and a communication device that transmits data to the relay device, the communication method including: a step of estimating a channel capacity related to wireless communication between the communication device and the relay device; a step of determining a transmission scheme of the data from the communication device to the relay device to be a scheme in which transmission efficiency is lower and transmission quality is higher as the channel capacity is larger, or to be a scheme in which the transmission quality is lower and the transmission efficiency is higher as the channel capacity is smaller; and a step of transmitting the data from the communication device to the relay device according to the determined transmission scheme.

### Advantageous Effects of Invention

According to at least one of the above-described aspects, communication resources can be effectively utilized in communication between a relay device that performs communication while moving and a transmission device on the ground.

### BRIEF DESCRIPTION OF DRAWINGS

FIG. 1 is a configuration diagram of a wireless communication system according to an embodiment.

FIG. 2 is a flowchart illustrating processing of a mobile relay station according to the embodiment.

FIG. 3 is a flowchart illustrating processing of a terminal station according to the embodiment.

FIG. 4 is a flowchart illustrating processing of a base station according to the embodiment.

### DESCRIPTION OF EMBODIMENTS

Hereinafter, embodiments of the present invention will be described in detail with reference to the drawings.

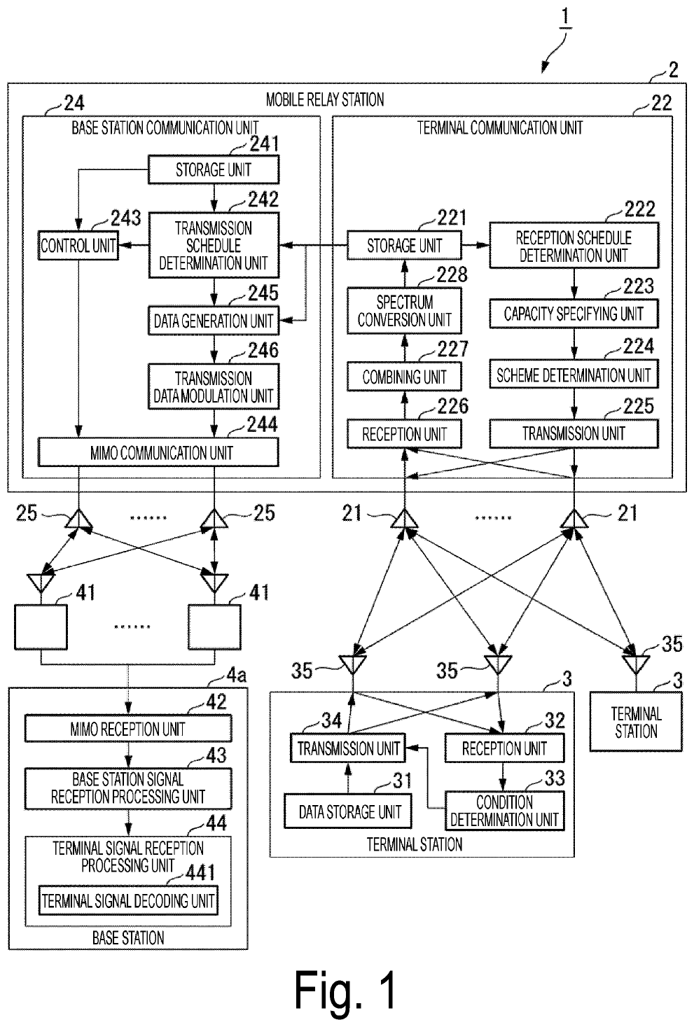

FIG. 1 is a configuration diagram of a wireless communication system 1 according to an embodiment. The wireless communication system 1 includes a mobile relay station 2, terminal stations 3, and a base station 4. Each of the numbers of mobile relay stations 2, terminal stations 3, and base stations 4 included in the wireless communication system 1 is arbitrary, but it is assumed that there is a large number of terminal stations 3.

The mobile relay station 2 is an example of a relay device that performs communication while moving. The mobile relay station 2 is provided in, for example, a low earth orbit (LEO) satellite. The LEO satellite has an altitude of 2000 km or less and orbits in the air over the earth once every about 1.5 hours. The terminal station 3 and the base station 4 are installed on the earth, for example, on the ground or on the sea. The terminal station 3 is, for example, an IoT terminal. The terminal station 3 collects data such as environmental data detected by a sensor and wirelessly transmits the collected data to the mobile relay station 2. FIG. 1 illustrates only two terminal stations 3. The mobile relay station 2 receives the data transmitted from each of the plurality of terminal stations 3 with wireless signals while moving above the earth and wirelessly transmits the received data to the base station 4. The base station 4 receives the data collected by the terminal stations 3 from the mobile relay station 2.

The mobile relay station 2 may be, for example, a relay station mounted on an unmanned aerial vehicle such as a geosynchronous satellite, drone, or high altitude platform station (HAPS). However, the relay station mounted on a geosynchronous satellite has a wide coverage area (footprint) on the ground, but has an extremely small link budget with respect to the IoT terminals installed on the ground because its altitude is high. Meanwhile, the relay station mounted on a drone or a HAPS has a high link budget, but has a narrow coverage area. Moreover, a battery is necessary in a drone and a solar panel is necessary in a HAPS. In the present embodiment, the mobile relay station 2 is mounted on the LEO satellite. Thus, the link budget falls within a limit, and, in addition, the LEO satellite has no air resistance and has low fuel consumption because the LEO satellite orbits outside the atmosphere. In addition, the footprint is also larger than that in a case where a relay station is mounted on a drone or a HAPS.

However, the mobile relay station 2 mounted on the LEO performs communication while moving at a high speed, and thus a Doppler shift occurs in wireless signals. Further, the relay station mounted on the LEO has a smaller link budget than the relay station mounted on the drone or HAPS. Therefore, the mobile relay station 2 receives wireless signals from the terminal stations 3 through a plurality of antennas and transmits the wireless signals to the base station 4 through a plurality of antennas. Communication quality can be improved by a diversity effect and beamforming effect of communication using the plurality of antennas. In the present embodiment, there will be described an example where the mobile relay station 2 relays wireless signals received from the terminal stations 3 through the plurality of antennas to the base station 4 by multiple input multiple output (MIMO). Note that the wireless signals may be relayed to the base station 4 by a method other than MIMO.

A configuration of each device will be described.

The mobile relay station 2 includes a plurality of first antennas 21, a terminal communication unit 22, a base station communication unit 24, and a plurality of second antennas 25. The terminal communication unit 22 includes a storage unit 221, a reception schedule determination unit 222, a capacity specifying unit 223, a scheme determination unit 224, a transmission unit 225, a reception unit 226, a combining unit 227, and a spectrum conversion unit 228.

The storage unit 221 stores position data of the terminal stations 3 and orbit data of the LEO satellite. The position data of the terminal stations 3 is represented by, for example, latitude and longitude. The orbit data of the LEO is data from which a position, speed, moving direction, and the like of the LEO satellite at an arbitrary time can be obtained. The storage unit 221 has a storage area for storing spectral data of a terminal uplink signal received from the terminal station 3.

The reception schedule determination unit 222 specifies timing when a signal is received from each terminal station 3 on the basis of the position data and the orbit data of the terminal stations 3 stored in the storage unit 221.

The capacity specifying unit 223 specifies a channel capacity in communication with the terminal station 3 at the reception timing determined by the reception schedule determination unit 222. For example, the capacity specifying unit 223 can obtain the channel capacity from an error rate of the signal received from the terminal station 3. Further, for example, the capacity specifying unit 223 may receive a control signal including a value of the channel capacity from the terminal station 3.

The scheme determination unit 224 determines a transmission scheme of data transmission by the terminal station 3 on the basis of the channel capacity specified by the capacity specifying unit 223. The scheme determination unit 224 determines the transmission scheme to be a scheme in which transmission efficiency is lower and transmission quality is higher as the channel capacity is larger, or to be a scheme in which the transmission quality is lower and the transmission efficiency is higher as the channel capacity is smaller. Specifically, the scheme determination unit 224 adopts the transmission scheme in which a multi-value number is larger as the channel capacity is smaller. The larger the multi-value number, the larger the amount of information per symbol, and the higher the transmission efficiency. On the other hand, the smaller the multi-value number, the lower a symbol error rate and the higher the transmission quality. Further, the scheme determination unit 224 increases the bit count of an error correction code as the channel capacity is smaller. The shorter the error correction code, the larger the amount of information of a payload with respect to a data frame, and the higher the transmission efficiency. On the other hand, the longer the error correction code, the larger the bit count in which an error can be corrected, and the higher the transmission quality. In other embodiments, an error detection code may be added instead of the error correction code. Even in the case of using the error detection code, the scheme determination unit 224 decreases the bit count of the error detection code as the channel capacity is larger. The shorter the error detection code, the larger the amount of information of the payload with respect to the data frame, and the higher the transmission efficiency. Further, the scheme determination unit 224 increases transmission power of the signal as the channel capacity is smaller. The larger the transmission power, the higher the transmission quality. Since the terminal station 3 having a small channel capacity performs transmission using a transmission scheme having high transmission efficiency and low transmission quality, a probability of occurrence of an error can be reduced by increasing the transmission power and reducing an SN ratio. Further, in a case where the channel capacity specified by the capacity specifying unit 223 is smaller than a predetermined threshold, the scheme determination unit 224 may determine not to communicate with the terminal station 3 at the reception timing determined by the reception schedule determination unit 222. That is, the scheme determination unit 224 may determine to transmit data at an opportunity when the next or subsequent channel capacity is large.

Note that, in other embodiments, the scheme determination unit 224 may determine the transmission scheme not for each terminal station 3 but for each area obtained by dividing the ground into a plurality of meshes.

The transmission unit 225 transmits notification information indicating the transmission scheme determined for each terminal station 3 by the scheme determination unit 224 as terminal downlink signals via the plurality of first antennas 21. That is, the notification information includes data in which an ID of terminal station 3 is associated with the determined transmission scheme. The notification information does not necessarily include the transmission schemes of all the terminal stations 3, and for example, it is sufficient that the notification information includes the transmission scheme related to the terminal station 3 including the reception timing determined by the reception schedule determination unit 222 within a certain period starting from a time point of transmitting the notification information. The notification information may include orbit data of the LEO satellite.

The reception unit 226 receives signals via the plurality of first antennas 21. The combining unit 227 combines a plurality of signals received by the reception unit 226 via the plurality of first antennas 21 according to a predetermined combination parameter. The combination parameter is represented by, for example, an offset of a phase and amplitude of each first antenna 21. Note that the combination parameter may be obtained on the basis of the signal reception timing and the positional relationship between the mobile relay station 2 and the terminal station 3 as a communication counterpart at the reception timing, or may be a constant value at all times.

The combining unit 227 reproduces the terminal uplink signal by combining the signals.

The spectrum conversion unit 228 converts the signal combined by the combining unit 227 into a frequency spectrum. The spectrum conversion unit 228 obtains the frequency spectrum of the received signal by fast Fourier transform (FFT), for example. The spectrum conversion unit 228 records spectral data indicating the generated frequency spectrum in the storage unit 221. The spectral data is represented by a combination of a frequency and power of the frequency.

The base station communication unit 24 transmits the spectral data indicating a waveform of the terminal uplink signal received by the terminal communication unit 22 to the base station 4 by MIMO. The base station communication unit 24 includes a storage unit 241, a transmission schedule determination unit 242, a control unit 243, a MIMO communication unit 244, a data generation unit 245, and a transmission data modulation unit 246.

The storage unit 241 stores a communication time zone with the base station 4 obtained in advance on the basis of the position of the base station 4 and an orbit of the LEO satellite. The storage unit 241 further stores in advance a weight of a base station downlink signal transmitted from each second antenna 25 for each transmission time in the communication time zone. The transmission time may be represented by, for example, an elapsed time from the transmission start timing. The weight for each transmission time is calculated on the basis of the orbit data of the LEO satellite and the position of each antenna station 41.

The transmission schedule determination unit 242 determines a transmission time zone for each spectral data on the basis of the number of pieces of the spectral data stored in the storage unit 221 and the communication time zone. For example, the transmission schedule determination unit 242 determines a transmission time of each piece of the spectral data by dividing the length of the communication time zone by the number of pieces of spectral data and determines the transmission time zone of each piece of the spectral data by separating the communication time zone by the transmission time.

The control unit 243 issues an instruction of the weight for each transmission time read from the storage unit 241 to the MIMO communication unit 244. The MIMO communication unit 244 establishes MIMO communication with the base station 4 according to a predetermined protocol.

The data generation unit 245 converts the spectral data stored in the storage unit 221 into a parallel signal and modulates the parallel signal. The modulated parallel signal is weighted with the weight instructed from the control unit 243 and is transmitted from each second antenna 25 as the base station downlink signal.

The terminal station 3 includes a data storage unit 31, a reception unit 32, a condition determination unit 33, a transmission unit 34, and one or a plurality of antennas 35. The terminal station 3 is an example of a communication device that transmits data to the relay device. The data storage unit 31 stores sensor data and the orbit data of the LEO satellite. The reception unit 32 receives the terminal downlink signals from the mobile relay station 2 via the plurality of antennas 35 and reads the notification information.

The condition determination unit 33 reads the transmission scheme associated with the ID of the local station from the notification information read by the reception unit 32, and determines the transmission scheme of the transmission unit 34. Further, the condition determination unit 33 determines the transmission time period of the terminal uplink signal on the basis of the orbit data of the LEO satellite. That is, the condition determination unit 33 determines the time zone in which the terminal station 3 exists within the coverage of the first antenna 21 of the mobile relay station 2 as the transmission time zone of the terminal uplink signal. Note that, in a case where the notification information read by the reception unit 32 stores information indicating that communication is not to be performed instead of the transmission scheme, the condition determination unit 33 determines not to transmit the terminal uplink signal.

The transmission unit 34 wirelessly transmits, from the antenna 35, the terminal uplink signal in which the sensor data stored in the data storage unit 31 is set as the terminal transmission data according to the transmission time zone and the transmission scheme determined by the condition determination unit 33. That is, the transmission unit 34 transmits the signal using the multi-value number, the error correction code, and the transmission power stored in the notification information from the mobile relay station 2. The transmission unit 34 transmits the signal by, for example, low power wide area (LPWA). Examples of the LPWA include LoRaWAN (registered trademark), Sigfox (registered trademark), long term evolution for machines (LTE-M), and narrow band (NB)-IoT, but any wireless communication scheme can be used. The transmission unit 34 may perform transmission with another terminal station 3 by time-division multiplexing, orthogonal frequency division multiplexing (OFDM), MIMO, or the like. The transmission unit 34 determines a channel to be used by the local station to transmit the terminal uplink signal and transmission timing by a method determined in advance in a wireless communication scheme to be used. Further, the transmission unit 34 may also perform beam formation of the signals to be transmitted from the plurality of antennas 35 by a method determined in advance in the wireless communication scheme to be used.

The base station 4 includes a plurality of antenna stations 41, a MIMO reception unit 42, a base station signal reception processing unit 43, and a terminal signal reception processing unit 44.

The antenna station 41 is arranged at a position far from another antenna station 41 so as to increase a difference in an angle of arrival of the signal from each of the plurality of second antennas 25 of the mobile relay station 2. Each antenna station 41 converts the base station downlink signal received from the mobile relay station 2 into an electrical signal and outputs the electrical signal to the MIMO reception unit 42.

The MIMO reception unit 42 aggregates the base station downlink signals received from the plurality of antenna stations 41. The MIMO reception unit 42 stores a weight for each reception time with respect to the base station downlink signal received by each antenna station 41 on the basis of the orbit data of the LEO satellite and the position of each antenna station 41. For example, the reception time may be represented by an elapsed time from reception start timing. The MIMO reception unit 42 multiplies the base station downlink signal input from each antenna station 41 by the weight corresponding to the reception time of the base station downlink signal and combines the received signals multiplied by the weights. The same weight may be used regardless of the reception time. The base station signal reception processing unit 43 demodulates and decodes the combined received signal, thereby obtaining demodulation information. The base station signal reception processing unit 43 outputs the demodulation information to the terminal signal reception processing unit 44.

The terminal signal reception processing unit 44 performs the reception processing for the terminal uplink signal. The terminal signal reception processing unit 44 decodes a symbol of the terminal uplink signal from the spectral data indicated by the demodulation information to obtain the terminal transmission data transmitted from the terminal station 3. In other words, the terminal signal reception processing unit 44 decodes the symbol of the terminal uplink signal by converting a frequency domain waveform indicated by the spectral data into a time domain waveform.

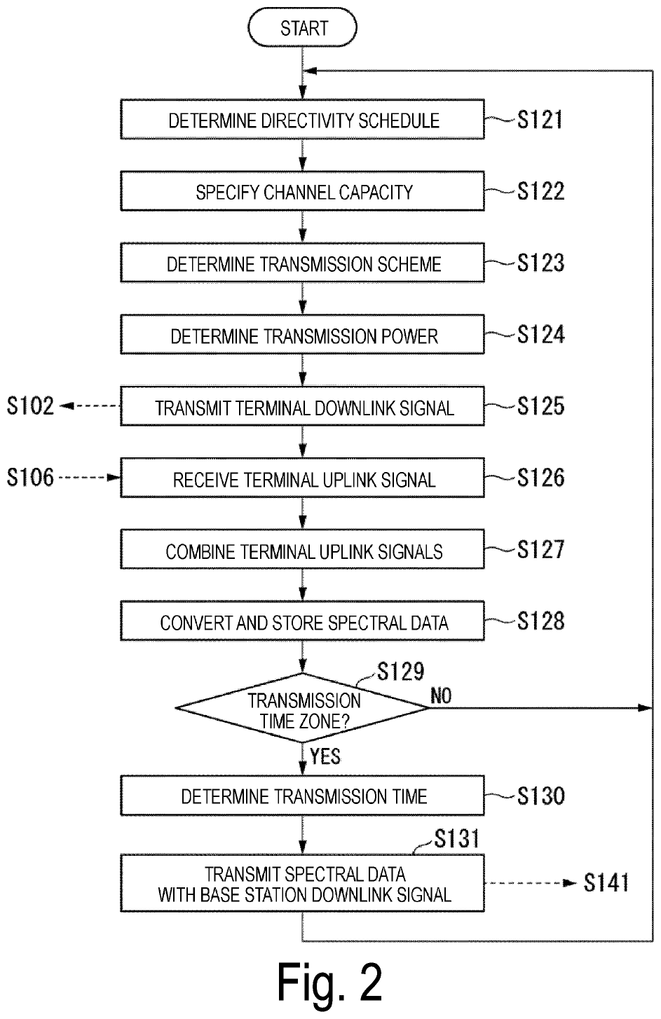

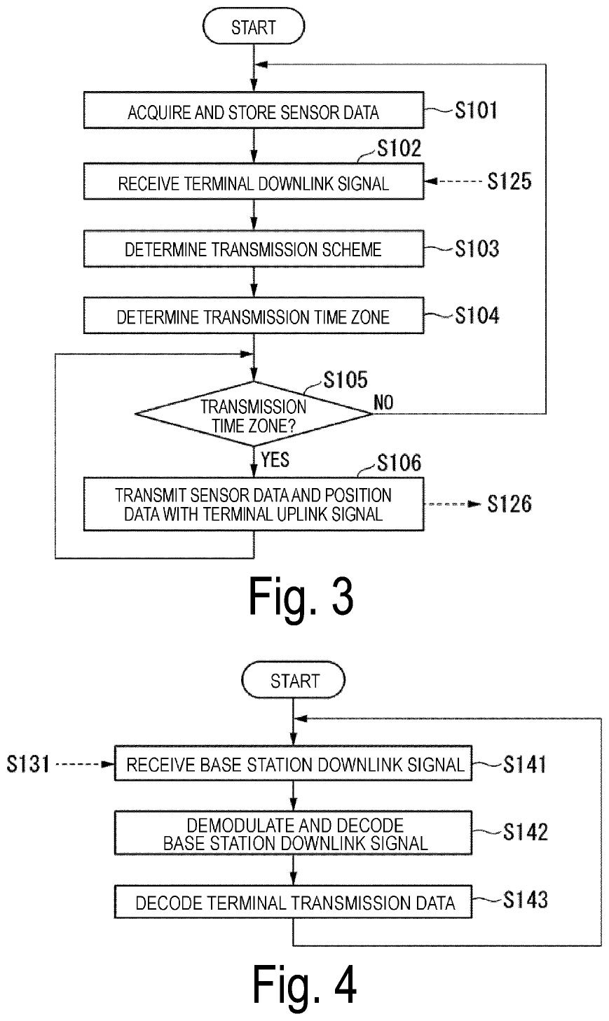

An operation of the wireless communication system 1 will be described. FIG. 2 is a flowchart illustrating processing of the mobile relay station 2 according to the embodiment. FIG. 3 is a flowchart illustrating processing of the terminal station 3 according to the embodiment. FIG. 4 is a flowchart illustrating processing of the base station 4 according to the embodiment. As illustrated in FIG. 2, the reception schedule determination unit 222 of the mobile relay station 2 determines, for each time, the terminal station 3 from which the terminal uplink signal is to be received on the basis of the position data of the terminal station 3 and the orbit data stored in the storage unit 221 (step S121). The capacity specifying unit 223 specifies the channel capacity in the communication at the reception timing determined in step S121 for each terminal station 3 (step S122).

The scheme determination unit 224 determines the transmission scheme of the data transmission for each terminal station 3 on the basis of the channel capacity specified in step S122 (step S123). That is, the scheme determination unit 224 determines the multi-value number and the bit count of the error correction code such that the larger the channel capacity, the lower the transmission efficiency and the higher the transmission quality. Further, the scheme determination unit 224 determines the transmission power such that the terminal station that has adopted the transmission scheme with lower transmission quality has larger transmission power (step S124). The transmission unit 225 transmits the notification information indicating the transmission scheme determined for each terminal station 3 by the scheme determination unit 224 as the terminal downlink signal via the plurality of first antennas 21 (step S125).

Meanwhile, the terminal station 3 acquires data detected by a sensor (not illustrated) provided outside or inside thereof and writes the acquired data to the data storage unit 31, as illustrated in FIG. 1 (step S101). The reception unit 32 of the terminal station 3 receives the terminal downlink signal transmitted from the mobile relay station 2 in step S125 (step S102). The condition determination unit 33 reads the transmission scheme associated with the ID of the local station from the notification information included in the terminal downlink signal received in step S101, and determines the transmission scheme of the transmission unit 34 (step S103). Further, the condition determination unit 33 determines the transmission time zone of the terminal uplink signal on the basis of the orbit data of the LEO satellite (step S104).

The transmission unit 34 of the terminal station determines whether the current time is included in the transmission time zone of the uplink signal determined by the condition determination unit 33 (step S105). In the case where the transmission unit 34 determines that the current time is not included in the transmission time zone of the uplink signal (step S105: NO), the terminal station 3 returns the processing to step S101.

On the other hand, in the case where the transmission unit 34 determines that the current time is included in the transmission time zone of the uplink signal (step S105: YES), the sensor data is read from the data storage unit 31, the read sensor data is set as the terminal transmission data, and the terminal transmission data is set for the terminal uplink signal of the transmission scheme determined in step S103. The transmission unit 34 wirelessly transmits the terminal uplink signal for which the terminal transmission data is set through the antenna 35 (step S106). The terminal station 3 returns the processing to step S105. Therefore, the terminal station 3 continuously transmits the uplink signal during the transmission time zone.

As illustrated in FIG. 2, the plurality of reception units 226 of the mobile relay station 2 receive the terminal uplink signals transmitted from the terminal stations 3 (step S126). Depending on the wireless communication schemes of the terminal stations 3 serving as transmission sources, there are some cases where the terminal uplink signal is received from only one terminal station 3 by time division at the same frequency, or there are some cases where the terminal uplink signals are simultaneously received from a plurality of terminal stations 3 at the same frequency. The combining unit 227 combines the terminal uplink signals received by the plurality of reception units 226 according to the combination parameter set in step S122 (step S127). The spectrum conversion unit 228 converts the signal combined by the combining unit 227 into spectral data and records the spectral data in the storage unit 221 (step S128).

The transmission schedule determination unit 242 determines whether the current time is included in the communication time zone with the base station 4 by referring to the storage unit 241 (step S129). In the case where the current time is not included in the communication time zone with the base station 4 (step S129: NO), the processing returns to step S121. On the other hand, in the case where the current time is included in the communication time zone with the base station 4 (step S129: YES), the transmission schedule determination unit 242 determines the transmission time for each spectral data on the basis of the number of pieces of the spectral data stored in the storage unit 221 and the length of the communication time zone with the base station 4 (step S130).

The data generation unit 245 performs parallel conversion for the spectral data stored in the storage unit 221, and the transmission data modulation unit 246 modulates the parallel-converted spectral data. The MIMO communication unit 244 weights the transmission data modulated by the transmission data modulation unit 246 with the weight instructed from the control unit 243 and generates the base station downlink signal to be transmitted from each second antenna 25. The MIMO communication unit 244 transmits each generated base station downlink signal from the second antenna 25 by MIMO (step S131). When transmitting all pieces of the spectral data stored in the storage unit 221, the mobile relay station 2 returns the processing to step S121.

As illustrated in FIG. 4, each antenna station 41 of the base station 4 receives the base station downlink signal from the mobile relay station 2 (step S141). Each antenna station 41 outputs, to the MIMO reception unit 42, a received signal that is an electrical signal into which the received base station downlink signal has been converted. The MIMO reception unit 42 synchronizes timings of the received signals received from the respective antenna stations 41. The MIMO reception unit 42 combines the received signals received by the respective antenna stations 41 on the basis of the weight. The base station signal reception processing unit 43 demodulates the combined received signal (step S142). The base station signal reception processing unit 43 outputs the waveform data obtained by decoding the demodulated received signal to the terminal signal reception processing unit 44.

The terminal signal decoding unit 441 of the terminal signal reception processing unit 44 decodes the symbol of the terminal uplink signal indicated by the waveform data to obtain the terminal transmission data transmitted from the terminal stations 3 (step S143). Note that the terminal signal decoding unit 441 can also use a decoding method having a large calculation load, such as successive interference cancellation (SIC). The base station 4 repeats the processing from step S141.

According to the present embodiment, the mobile relay station 2 varies a sampling target band of the waveform data on the basis of the channel capacity related to the communication with the terminal station 3. Specifically, the mobile relay station 2 generates the waveform data such that the target band becomes wider as the channel capacity is larger. Therefore, the mobile relay station 2 can effectively use communication resources while preventing missing of received data. In other words, the wireless communication system 1 can transmit information of a wide band in the case where the channel capacity is large.

As described above, according to the above-described embodiment, the mobile relay station 2 determines the transmission scheme of the data from the terminal station 3 to the mobile relay station 2 to be a scheme in which the larger the channel capacity, the lower the transmission efficiency and the higher the transmission quality. Thereby, the mobile relay station 2 can effectively use the communication resources in the communication between the terminal station 3 and the mobile relay station 2.

The mobile relay station 2 includes a processor, a memory, an auxiliary storage device, and the like connected by a bus and executes a relay program to function as a device including the terminal communication unit 22 and the base station communication unit 24. Examples of the processor include a central processing unit (CPU), a graphic processing unit (GPU), and a microprocessor.

The relay program may be recorded on a computer-readable recording medium. The computer-readable recording medium is a storage device such as a magnetic disk, a magneto-optical disk, an optical disk, or a semiconductor memory, for example. The relay program may be transmitted via an electrical communication line.

All or some of the functions of the mobile relay station 2 may be implemented by using a custom large scale integrated circuit (LSI) such as an application specific integrated circuit (ASIC) or a programmable logic device (PLD). Examples of the PLD include a programmable array logic (PAL), a generic array logic (GAL), a complex programmable logic device (CPLD), and a field programmable gate array (FPGA). Such an integrated circuit is also included in the examples of the processor.

### OTHER EMBODIMENTS

Although embodiment has been described in detail with reference to the drawings, specific configurations are not limited to the above-described configurations, and various design changes and the like can be made thereto. That is, in other embodiments, the order of the above-described processing may be changed as appropriate. Further, some pieces of processing may be executed in parallel.

The mobile relay station 2 according to the above-described embodiment may be configured with a single computer. Alternatively, the configuration of the mobile relay station 2 may be separately arranged in a plurality of computers, and the plurality of computers may function as the mobile relay station 2 in cooperation with each other.

According to the above-described embodiment, the scheme determination unit 224 determines the multi-value number and the error correction code, but the embodiment is not limited thereto. For example, in another embodiment, the multi-value number may be set to a fixed value, and the scheme determination unit 224 may determine only the error correction code or the error detection code. In another embodiment, the bit count of the error correction code or the error detection code may be set to a fixed value, and the scheme determination unit 224 may determine only the multi-value number. Further, according to the above-described embodiment, the scheme determination unit 224 determines the transmission power, but the present embodiment is not limited thereto. For example, the transmission power in another embodiment may be a fixed value.

According to the above-described embodiment, the scheme determination unit 224 of the mobile relay station 2 determines the transmission scheme of the terminal station 3, but the present embodiment is not limited thereto. For example, in other embodiments, the mobile relay station 2 may include the channel capacity of each terminal station 3 in the downlink signal, and each terminal station 3 may determine the transmission scheme on the basis of the channel capacity. That is, in another embodiment, the terminal station 3 may include the scheme determination unit 224. In still another embodiment, each terminal station 3 may specify the channel capacity on the basis of the orbit of the LEO satellite. That is, in the wireless communication system 1, the capacity specifying unit 223 and the scheme determination unit 224 may be included in the mobile relay station 2 or may be included in the terminal station 3.

In the above-described embodiment, the mobile relay station 2 is mounted on the LEO satellite, but the present embodiment is not limited thereto. For example, the mobile relay station 2 according to another embodiment may be mounted on another flying object such as a geosynchronous satellite, a drone, or a HAPS. Further, in the above-described embodiment, the mobile relay station 2 moves above the earth, and the terminal stations 3 and the base station 4 are provided on the earth. However, the wireless communication system 1 according to another embodiment may be used for a celestial body other than the earth, such as the moon.

In the above-described embodiment, the capacity specifying unit 223 of the mobile relay station 2 specifies the channel capacity related to the communication with the base station 4 by the MIMO communication with the base station 4, but the present embodiment is not limited thereto. For example, the capacity specifying unit 223 according to another embodiment may store the channel capacity related to the communication with the base station 4 for each time in the storage unit 241 in advance and read the channel capacity from the storage unit 241. Further, the capacity specifying unit 223 according to another embodiment may obtain an angle of elevation between the mobile relay station 2 and the base station 4 on the basis of the orbit data and the position of the base station 4 and estimate the channel capacity on the basis of the angle of elevation.

In a case where the channel capacity specified by the capacity specifying unit 223 is smaller than a predetermined threshold, the mobile relay station 2 according to the above-described embodiment determines to transmit data at an opportunity when the next or subsequent channel capacity is large. In another embodiment, in a case where a plurality of LEO satellites constitute a constellation, data may be transmitted to the mobile relay station 2 mounted on another LEO satellite constituting the constellation. The plurality of mobile relay stations 2 constituting the constellation mutually transmits and receives reception status information related to reception statuses of the terminal uplink signals to recognize reception statuses of the other mobile relay stations 2. Here, in the case where the channel capacity specified by the capacity specifying unit 223 is smaller than a predetermined threshold, the transmission unit 225 of the mobile relay station 2 stores the fact that communication with the terminal station 3 has failed in the reception status information. Thereby, the reception schedule determination unit 222 of another mobile relay station 2 can determine a reception schedule from the terminal station 3 with which the communication has failed on the basis of the reception status information, and the scheme determination unit 224 can determine the transmission scheme of data transmission by the terminal station 3.

### REFERENCE SIGNS LIST

1 Wireless communication system
2 Mobile relay station
21 First antenna
22 Terminal communication unit
221 Storage unit
222 Reception schedule determination unit
223 Capacity specifying unit
224 Scheme determination unit
225 Transmission unit
226 Reception unit
227 Combining unit
228 Spectrum conversion unit
24 Base station communication unit
241 Storage unit
242 Transmission schedule determination unit
243 Control unit
244 MIMO communication unit
245 Data generation unit
246 Transmission data modulation unit
25 Second antenna
3 Terminal station
31 Data storage unit
32 Reception unit
33 Condition determination unit
34 Transmission unit
35 Antenna
4 Base station
41 Antenna station
42 MIMO reception unit
43 Base station signal reception processing unit
44 Terminal signal reception processing unit

1. A communication system including a relay device that performs communication while moving and a communication device that transmits data to the relay device, the communication system comprising:
a capacity specifier that specifies a channel capacity related to wireless communication between the communication device and the relay device; and
a scheme determiner that determines a transmission scheme of the data from the communication device to the relay device to be a scheme in which transmission efficiency is lower and transmission quality is higher as the channel capacity is larger, or to be a scheme in which the transmission quality is lower and the transmission efficiency is higher as the channel capacity is smaller.

2. The communication system according to claim 1, wherein
the scheme determiner increases a multi-value number of the transmission scheme as the channel capacity is smaller.

3. The communication system according to claim 1, wherein
the scheme determiner decreases a data amount of an error correction code or an error detection code of the transmission scheme as the channel capacity is smaller.

4. The communication system according to claim 1, wherein
the scheme determiner increases transmission power related to transmission of the data as the channel capacity is smaller.

5. The communication system according to claim 1, wherein
the capacity specifier and the scheme determiner are included in the relay device,
the relay device includes a notifier that notifies the communication device of the determined transmission scheme, and
the communication device includes a transmitter that transmits the data to the relay device according to the transmission scheme notified by the relay device.

6. The communication system according to claim 1, wherein
the scheme determiner determines not to transmit the data in a case where the channel capacity is smaller than a predetermined threshold.

7. A communication method between a relay device that performs communication while moving and a communication device that transmits data to the relay device, the communication method comprising:
estimating a channel capacity related to wireless communication between the communication device and the relay device;
determining a transmission scheme of the data from the communication device to the relay device to be a scheme in which transmission efficiency is lower and transmission quality is higher as the channel capacity is larger, or to be a scheme in which the transmission quality is lower and the transmission efficiency is higher as the channel capacity is smaller; and
transmitting the data from the communication device to the relay device according to the determined transmission scheme.
